(19) United States
(12) Patent Application Publication
(10) Pub. No.: US 2013/0181175 A1
(43) Pub. Date: Jul. 18, 2013

(54) LOW-TEMPERATURE CO-PRECIPITATION METHOD FOR FABRICATING TCO POWDERS

(71) Applicants: Hsin-Chun LU, Tao-Yuan (TW); Chen-Sung Chang, Tao-Yuan (TW); Chun-Lung Chu, Tao-Yuan (TW); Min-Hsiang Liao, Tao-Yuant (TW); Ming-Hung Liu, Tao-Yuan (TW); Mei-Ching Chiang, Tao-Yuan (TW)

(72) Inventors: Hsin-Chun LU, Tao-Yuan (TW); Chen-Sung Chang, Tao-Yuan (TW); Chun-Lung Chu, Tao-Yuan (TW); Min-Hsiang Liao, Tao-Yuant (TW); Ming-Hung Liu, Tao-Yuan (TW); Mei-Ching Chiang, Tao-Yuan (TW)

(21) Appl. No.: 13/350,945

(22) Filed: Jan. 16, 2012

(51) Int. Cl. H01B 1/08

(52) U.S. Cl. 252/519.5; 252/518.1; 252/520.1

(57) ABSTRACT

The present invention discloses a low-temperature co-precipitation method for fabricating TCO powders, which comprises steps: respectively dissolving two or more metals/metal salts in solvents to obtain metal ion solutions; mixing the metal ion solutions to form a precursor solution having a specified composition; enabling a co-precipitation reaction at a temperature lower than 45° C. via adding precipitant in two stages, controlling the temperature of precipitation reactions and undertaking aging processes; flushing, filtering, drying and calcining the precipitates to obtain TCO powders having a specified composition and improved quality.

### BACKGROUND OF THE INVENTION

1. Field of the Invention

The present invention relates to a method for fabricating TCO powders, particularly to a co-precipitation method for fabricating TCO powders with more precise composition and higher electrical conductivity.

2. Background of the Invention

Transparent conductive oxide (TCO) film is referred to a film having high electrical conductivity, high visible light transmittance, and high infrared light reflectivity. TCO films are widely used in various electronic, optical and optoelectronic devices, such as solar cells, flat panel displays, touch panels, transparent heating elements, anti-electrostatic films, anti-electromagnetic wave films. TCO films are usually semiconductor metal oxides having an energy gap greater than the photon energy of visible light as the material thereof to attain the transparency of visible light. Further, dopant is added to the semiconductor metal oxide to increase the electrical conductivity. For examples, a tiny amount of tin is added into indium oxide to form indium tin oxide (ITO); zinc oxide is doped with aluminum to form aluminum-doped zinc oxide (AZO). The proportion of the metal dopant is a critical factor determining the electrical conductivity of TCO films in addition to the fabrication method and the fabrication conditions thereof. At present, TCO films are mainly fabricated by sputtering deposition, wherein a TCO target made of TCO powders is sputtered to form TCO films in a vacuum magnetron sputtering system. However, the composition homogeneity of the mixed oxides is limited by the dopant distribution and the grain size within the sputtering target. Besides, the impurities in the target affect the electrical conductivity, the light transmittance, and the substrate adhesion of TCO films. Therefore, the related fields have paid much attention on the sputtering TCO target and the material thereof the multi-component TCO powders.

At present, multi-component TCO powders are mainly fabricated by solid-state reaction method and chemical methods. In the solid-state reaction method, metal oxide powders, which have been mixed at a specified ratio, react in solid state to form multi-component TCO powders. However, the quality of the powders made by the solid-state reaction method is likely to be degraded by the large grain size of the original powders, uneven mixing, and impurities coming from the mixing medium. The inferior quality of the solid-state reaction made oxide powders impairs the properties of the sputtering targets made from these oxide powders and the properties of the TCO films made from the resulting sputtering targets.

Among the chemical methods, the co-precipitation method is the most promising method for mass production of the multi-component TCO powders. The co-precipitation method adopts two or more metals/metal salts as the initial materials. The metals/metal salts are dissolved in a solvent to obtain a homogeneous metal ion solution. An appropriate amount of precipitant is added to the metal ion solution to form precipitates. The precipitates are then flushed, filtered, dried, and calcined to obtain multi-component TCO powders. However, it is found by the research team of the Inventors: In using the co-precipitation method to fabricate doped multi-component TCO powders (such as the powder of AZO, GZO, IZO, ITO, or ATO (Antimony Tin Oxide)), some metal ions will not form hydroxides but will combine with the precipitant (such as ammonia or sodium hydroxide) directly to form oxides if the exothermal neutralization reaction between the precipitant and the precursor solution releases heat too fast and raises the temperature of the precipitation solution to over 50° C. In addition, if the final pH value for the precipitation is too high, some hydroxides will re-dissolve and form complex compounds. In these cases, the conventional technologies cannot obtain a homogeneous multi-component nano-sized TCO powders having required dopants.

Therefore, the manufacturers are eager to develop a method for fabricating a high-quality and high-homogeneity nano-sized TCO powders with a precise dopant concentration.

Accordingly, the present invention proposes a low-temperature co-precipitation method for fabricating TCO powders to overcome the conventional problems.

### SUMMARY OF THE INVENTION

The primary objective of the present invention is to provide a low-temperature co-precipitation method for fabricating TCO powders, which promotes the properties of the multi-component TCO powders to improve the quality of the sputtering targets and the TCO films.

To achieve the abovementioned objective, the present invention proposes a low-temperature co-precipitation method for fabricating TCO powders, which comprises steps: respectively dissolving a first metal and a second metal in solvents to obtain a first metal ion solution and a second metal ion solution; mixing the first metal ion solution and the second metal ion solution to form a precursor solution and agitating the precursor solution; at a temperature lower than 45° C., adding a precipitant into the precursor solution, modifying the precursor solution to have a first pH value to make the precursor solution partially precipitate and form a first precipitation solution, and undertaking a first aging process; at a temperature lower than 45° C., adding a precipitant into the first precipitation solution, modifying the first precipitation solution to have a second pH value to make the first precipitation solution fully precipitate and form a second precipitation solution, and undertaking a second aging process; filtering the second precipitation solution to obtain a precipitate cake; flushing the precipitate cake with deionized water, agitating and dispersing the precipitate cake, and repeating the filtering, flushing, agitating and dispersing processes until the anion concentrations of the precipitate cake are lower than allowed values; drying the precipitate cake to obtain co-precipitation precursor hydroxide powders; and calcining the co-precipitation precursor hydroxide powders in a high-temperature furnace to obtain TCO powders.

The present invention can simultaneously complete synthesis and refinement in the co-precipitation process. Further, the present invention can precisely control the powder composition and the component distribution homogeneity to upgrade the quality of the TCO powders. Thereby the quality of the TCO sputtering targets made from the TCO powders fabricated by the method of the present invention and the quality of the TCO films made from the resulting TCO sputtering targets is promoted.

Below, the embodiments are described in details to enable clear understanding of the objectives, technical contents, characteristics and accomplishments of the present invention.

### BRIEF DESCRIPTION OF THE DRAWINGS

FIG. 1 is a flowchart of a low-temperature co-precipitation method for fabricating TCO powders according to one embodiment of the present invention;

FIG. 2 is a flowchart of fabricating transparent conductive AZO powders according to one embodiment of the present invention;

FIG. 3 shows the result of the XRD analysis of the transparent conductive AZO powders fabricated according to one embodiment of the present invention; and

FIG. 4 shows an SEM photograph of the transparent conductive AZO powders fabricated according to one embodiment of the present invention.

### DETAILED DESCRIPTION OF THE INVENTION

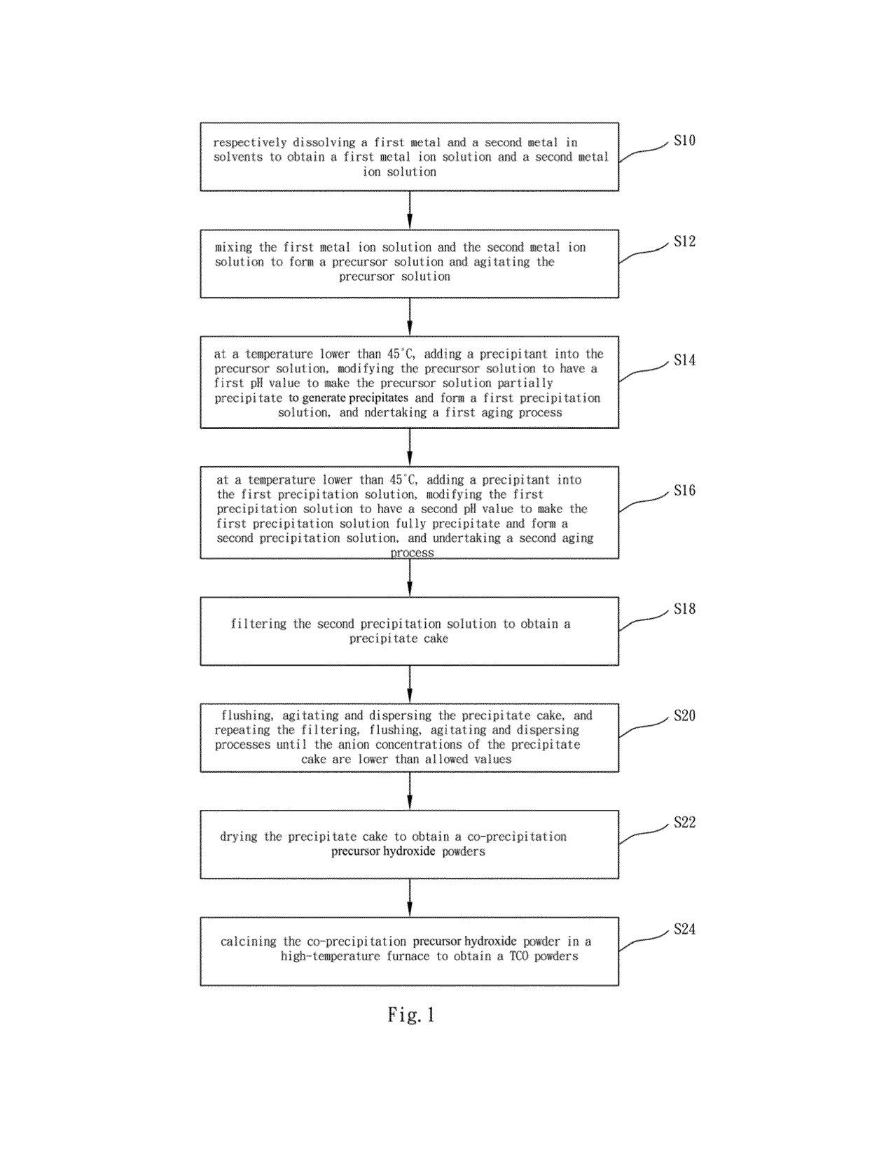

Refer to FIG. 1 a flowchart of a low-temperature co-precipitation method for fabricating TCO powders according to one embodiment of the present invention. In Step S10, respectively dissolve a first metal and a second metal in solvents to form a first metal ion solution and a second metal ion solution. The solvent is a strong acid (such as nitric acid or hydrochloric acid), an aqueous solution (such as a nitric acid aqueous solution or a hydrochloric acid aqueous solution), or water. Each of the first metal and the second metal is selected from a group consisting of indium, zinc, gallium, tin, aluminum, antimony, and metal salts. The metal salt is selected from a group consisting of indium nitrate, zinc nitrate, tin nitrate, aluminum nitrate, gallium nitrate, indium chloride, zinc chloride, aluminum chloride, and tin chloride. Besides, the first metal is different from the second metal. In Step S12, mix the first metal ion solution and the second metal ion solution by a required ratio to form a precursor solution having a specified composition, and use an agitator to agitate the precursor solution uniformly. In Step S14, at a temperature lower than 45° C., rapidly add a precipitant (such as ammonium hydroxide, sodium hydroxide, or potassium hydroxide) into the precursor solution when the precursor solution is agitated, modify the precursor solution to have a first pH value (ranging from 0 to 4.5 preferably) to make the precursor solution partially precipitate to form a first precipitation solution, and undertake a first aging process for an interval of time (3-24 hours preferably). In Step S16, at a temperature lower than 45° C., add a precipitant into the first precipitation solution, modify the first precipitation solution to have a second pH value (ranging from 6.0 to 9.5 preferably) to make the first precipitation solution fully precipitate and form a second precipitation solution, and undertake a second aging process for an interval of time (6-72 hours preferably).

As the two-stages of co-precipitation and aging in Step S14 and Step S16 are undertaken at a temperature lower than 45° C., the temperature of the exothermal reactions of the acid-base neutralization and precipitation is controlled. Thereby, oxide formation and hydroxide redissolving are inhibited. Therefore, the present invention can overcome the conventional problem: The temperature of the precipitation solution is rapidly increased by the heat generated by the neutralization reaction of the precursor solution and the basic precipitant. If the temperature of the precipitation solution is higher than 50° C., the metal ions of some components will directly combine with the precipitant to form oxides. The present invention can also overcome the conventional problem: The conventional technology cannot obtain TCO powders having the desired dopant concentration and homogeneous compositional distribution when the pH value of the final precipitation is too high, which results in some hydroxides forming complex compounds and then redissolve. In Step S18, filter the second precipitation solution to obtain a precipitate cake via a centrifugal filtering process or a pressure filtering process. In Step S20, flush the precipitate cake with deionized water, agitate and disperse the precipitate cake, and repeat the filtering, flushing, agitating and dispersing processes until the anion concentrations of the precipitate cake are lower than allowed values. In the present invention, the nitrate anion concentration or the chloride anion concentration in the precipitate cake must be lower than 500 ppm. In Step S22, dry the precipitate cake to obtain a co-precipitation precursor hydroxide powders via a spray-drying process or a heat-drying process at a temperature lower than 80° C. In Step S24, calcine the co-precipitation precursor hydroxide powders in a high-temperature furnace to obtain TCO powders at a temperature of 500-1200° C. for 2-10 hours. The TCO powders are referred to the powders of aluminum-doped zinc oxide (AZO), gallium-doped zinc oxide (GZO), indium zinc oxide (IZO) or ITO.

The present invention has the following advantages: (1) TCO powders can be used for mass production with simple equipment, low cost, easy processes; the synthesis and refinement can be simultaneously completed in precipitation; (2) The concentration of each component can be precisely controlled to have an error lower than 0.5%; (3) The purity, grain sizes, grain size distribution and phases of the powders can be controlled via controlling the precipitation conditions and the calcination conditions; and (4) TCO powders can be obtained at a low calcination temperature with high stability and high reproducibility of quality.

Because of abundant reserve, cheapness and non-toxicity, zinc is extensively used in various fields. In one embodiment, the present invention adopts zinc as the first metal and aluminum, gallium or indium as the second metal, wherein the preferred dopant concentration is 3-7 wt % gallium, 1-3 wt % aluminum, or 10-30 wt % indium. Via the process shown in FIG. 1, the present invention can fabricate multi-component TCO powders, such as a powder of AZO, GZO or IZO.

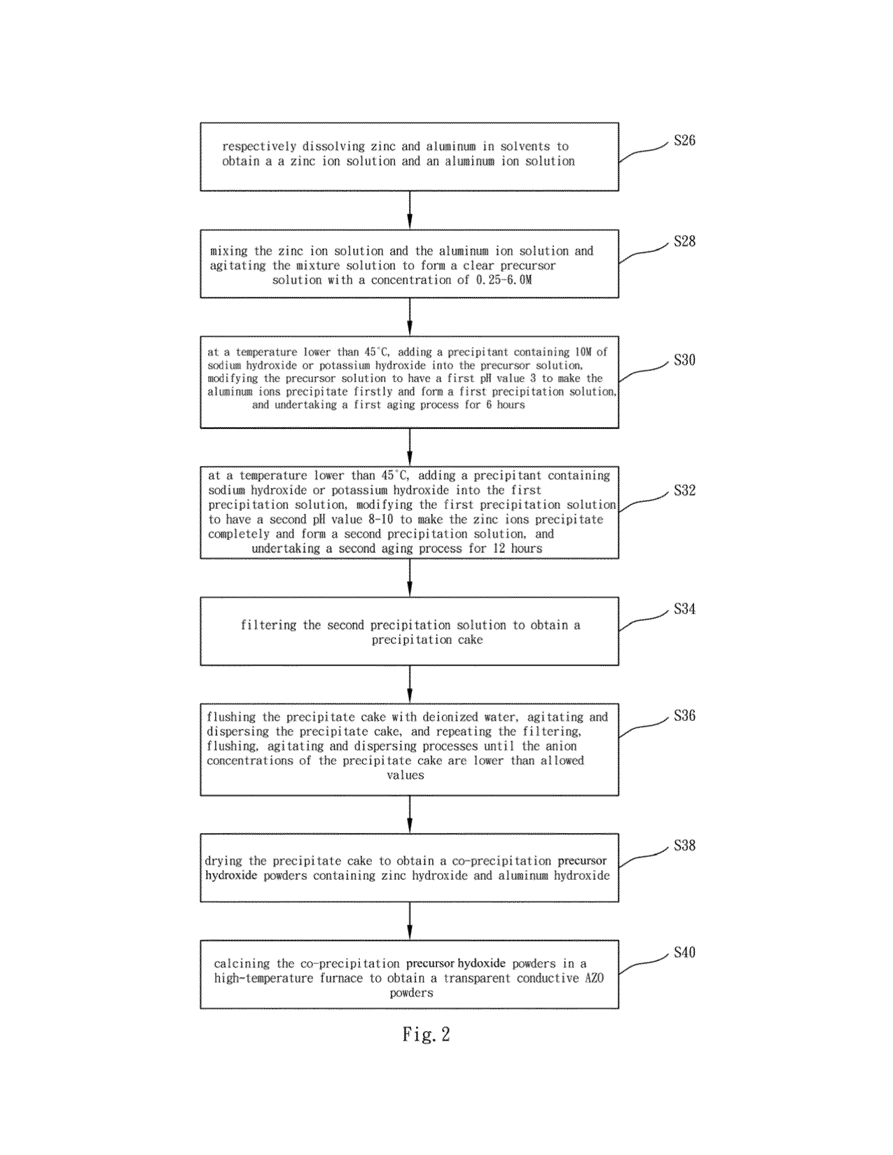

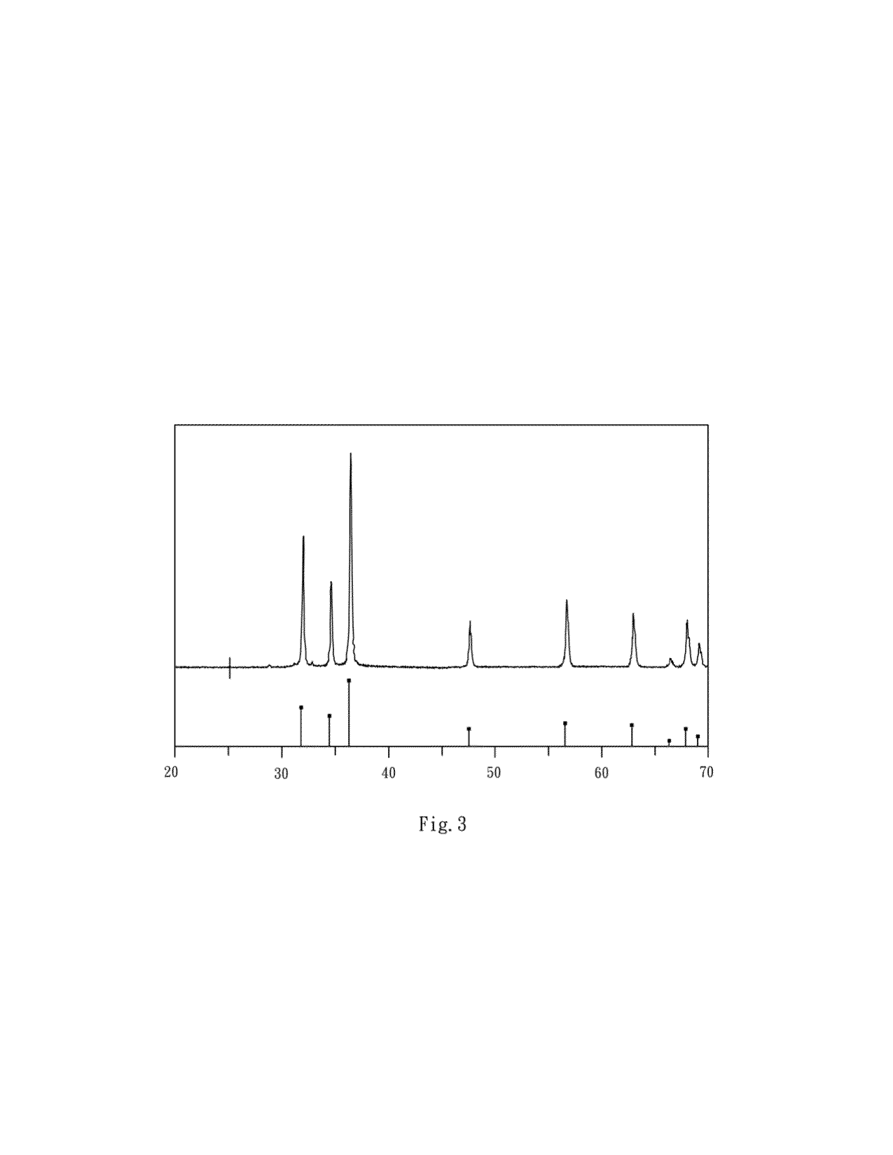

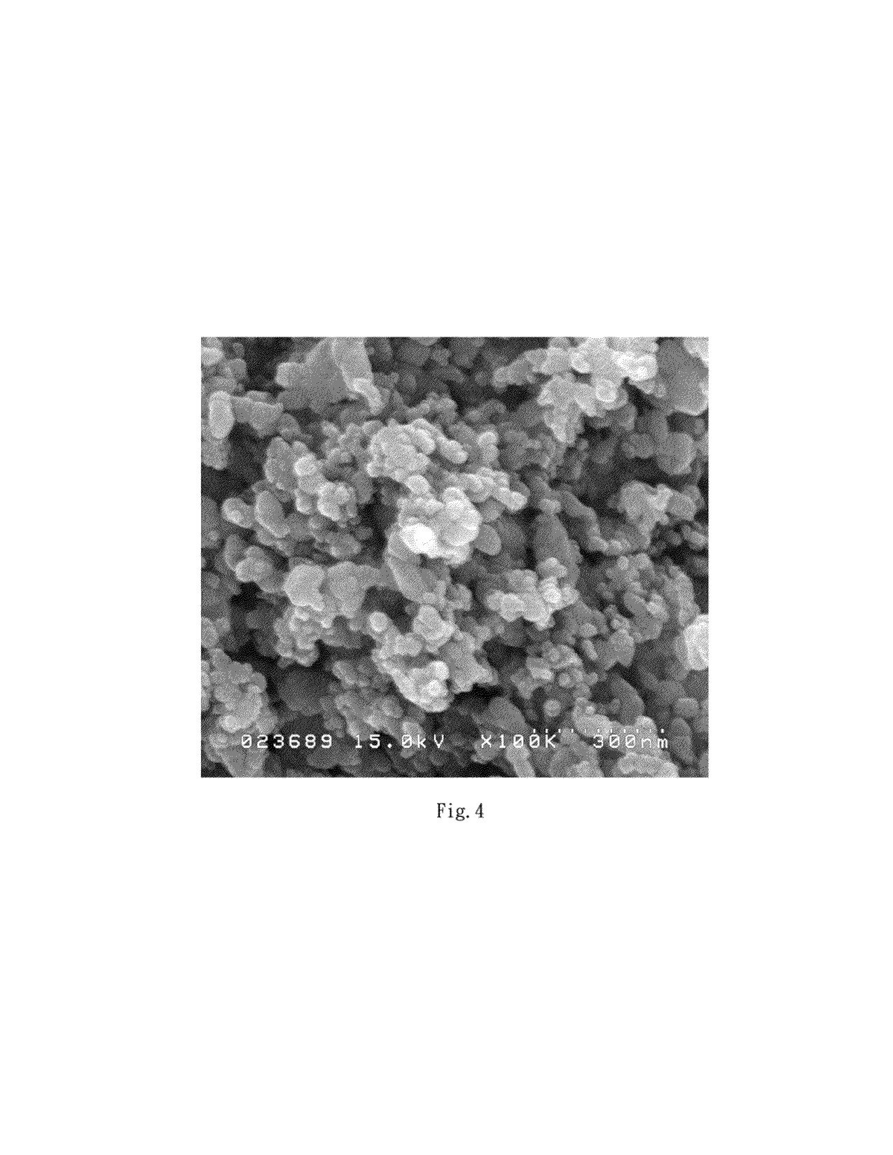

Refer to FIG. 2 a flowchart of fabricating crystalline nano-sized AZO powders according to one embodiment of the present invention. In Step S26, adopt zinc as the first metal and dissolve zinc in a nitric acid aqueous solution to form a zinc ion solution; adopt aluminum as the second metal and dissolve 2 wt % of aluminum in a nitric acid aqueous solution to form an aluminum ion solution. In Step S28, mix the zinc ion solution and the aluminum ion solution and agitate the mixture solution to form a clear precursor solution with a concentration of 0.25-6.0M. In Step S30, at a temperature lower than 45° C., add a precipitant containing 10M of sodium hydroxide or potassium hydroxide into the precursor solution, modify the precursor solution to have a first pH value 3 to make the aluminum ions (Al³⁺) precipitate firstly and form a first precipitation solution, and undertake a first aging process for 6 hours, wherein the dopant (aluminum) ions in the first precipitation react homogeneously to form aluminum hydroxide precipitates. After 6 hours of aging, the hydroxide precipitates completely. In Step S32, at a temperature lower than 45° C., add a precipitant containing sodium hydroxide or potassium hydroxide into the first precipitation solution, modify the first precipitation solution to have a second pH value 8-10 and form a second precipitation solution, wherein zinc ion completely precipitate, and undertake a second aging process for 12 hours. When the hydroxide ion of the precipitant does not reach a specified equivalent concentration, the precipitation reaction will be incomplete. In such a case, the composition of the precursor precipitates is not the same as the designed composition. When the concentration of hydroxide ion is too high, the precipitates will redissolve to generate complex compounds because zinc hydroxide is an amphiprotic compound. In both cases, the composition of the resultant powders is hard to control precisely. Therefore, the second pH value of the precipitation solution using hydroxide ion as the precipitant is controlled to be within a specified range so that zinc ion can react completely and homogeneously to form the precipitates of zinc hydroxide. In Step S34, filter the second precipitation solution to obtain a precipitate cake via a centrifugal filtering process or a pressure filtering process. In Step S36, flush the precipitate cake with deionized water, agitate and disperse the precipitate cake, and repeat the filtering, flushing, agitating and dispersing processes until the anion concentrations of the precipitate cake are lower than allowed values. The nitrate anion concentration or the chloride anion concentration in the precipitate cake must be lower than 500 ppm. In Step S38, dry the precipitate cake to obtain a co-precipitation precursor hydroxide powders containing zinc hydroxide and aluminum hydroxide via a spray-drying process or a heat-drying process at a temperature lower than 80° C. In Step S40, calcine the co-precipitation precursor hydroxide powders in a high-temperature furnace at a temperature of 600° C. for 2 hours to obtain transparent conductive AZO powders. Then, the AZO powders are examined with material test apparatuses, such as XRD (X-Ray Diffractometer) and SEM (Scanning Electron Microscope). Refer to FIG. 3 and FIG. 4. The results of XRD and SEM analyses prove that the method of the present invention can successfully fabricate nano-sized transparent conductive crystalline AZO powders. The AZO powders fabricated by the method of the present invention is then ground, formulated, agglomerated, cold isostatic pressing (CIP) strengthened, dewaxed, and sintered to obtain an AZO sputtering target having a density of 5.575 g/cm³, a relative density of 99.575% (the theoretical density of AZO is 5.60 g/cm³), and a resistivity of 5.4*10⁻⁴ Ω·m. The AZO sputtering target can be used to deposit a transparent conductive AZO film having a resistivity of 3.0*10⁻⁴ Ω·m and an average visible light transmittance greater than 80% by RF magnetron sputtering.

In conclusion, the present invention can simultaneously complete synthesis and refinement in the co-precipitation process. Further, the present invention can effectively upgrade the quality of TCP powders via controlling the composition and the compositional distribution homogeneity of the TCO powders. Thereby the quality of the TCO sputtering target made from the TCO powders fabricated with the method of the present invention and the quality of the TCO film made from the resulting TCO sputtering target are promoted.

The embodiments described above are only to exemplify the present invention but not to limit the scope of the present invention. Any equivalent modification or variation according to the characteristics and spirit of the present invention is to be also included within the scope of the present invention.

What is claimed is:

1. A low-temperature co-precipitation method for fabricating transparent conductive oxide powders, comprising
Step (a): respectively dissolving a first metal and a second metal in solvents to form a first metal ion solution and a second metal ion solution;
Step (b): mixing said first metal ion solution and said second metal ion solution to form a precursor solution, and use an agitator to agitate said precursor solution;
Step (c): at a temperature lower than 45° C., adding a precipitant into said precursor solution, modifying said precursor solution to have a first pH value to make said precursor solution partially precipitate to generate precipitates and form a first precipitation solution, and undertaking a first aging process;
Step (d): at a temperature lower than 45° C., adding said precipitant into said first precipitation solution, modifying said first precipitation solution to have a second pH value to make said first precipitation solution fully precipitate to form a second precipitation solution, and undertaking a second aging process;
Step (e): filtering said second precipitation solution to obtain a precipitate cake;
Step (f): flushing, agitating and dispersing said precipitate cake; filtering, flushing, agitating and dispersing said precipitate cake repeatedly until anion concentrations of said precipitate cake are lower than allowed values;
Step (g): drying said precipitate cake to obtain co-precipitation precursor hydroxide powders; and
Step (h): calcining said co-precipitation precursor hydroxide powders in a high-temperature furnace to obtain transparent conductive oxide powders.

2. The low-temperature co-precipitation method for fabricating transparent conductive oxide powders according to claim 1, wherein each of said first metal and said second metal is selected from a group consisting of indium, zinc, gallium, aluminum, tin, antimony, and metal salts, and wherein said metal salts are selected from a group consisting of indium nitrate, zinc nitrate, gallium nitrate, aluminum nitrate, tin nitrate, indium chloride, zinc chloride, gallium chloride, aluminum chloride, and tin chloride.

3. The low-temperature co-precipitation method for fabricating transparent conductive oxide powders according to claim 2, wherein said transparent conductive oxide powder is a powder of AZO (aluminum-doped zinc oxide), GZO (gallium-doped zinc oxide), IZO (indium zinc oxide) or ITO (indium tin oxide).

4. The low-temperature co-precipitation method for fabricating transparent conductive oxide powders according to claim 1, wherein said solvent is nitric acid, hydrochloric acid, a nitric acid aqueous solution, a hydrochloric acid aqueous solution, or water.

5. The low-temperature co-precipitation method for fabricating transparent conductive oxide powders according to claim 1, wherein said precipitant is ammonium hydroxide, sodium hydroxide, or potassium hydroxide.

6. The low-temperature co-precipitation method for fabricating transparent conductive oxide powders according to claim 1, wherein in said Step (c), said first pH value ranges from 0 to 4.5, and said first aging process is undertaken for 3-24 hours.

7. The low-temperature co-precipitation method for fabricating transparent conductive oxide powders according to claim 1, wherein in said Step (d), said second pH value ranges from 6.0 to 9.5, and said second aging process is undertaken for 6-72 hours.

8. The low-temperature co-precipitation method for fabricating transparent conductive oxide powders according to claim 1, wherein in said Step (e), said second precipitation solution is filtered with a centrifugal filtering process or a pressure filtering process.

9. The low-temperature co-precipitation method for fabricating transparent conductive oxide powders according to claim 1, wherein in said precipitate cake, nitrate anion has a concentration lower than 500 ppm, and chloride anion has a concentration lower than 500 ppm.

10. The low-temperature co-precipitation method for fabricating transparent conductive oxide powders according to claim 1, wherein in said Step (g), said precipitate cake is dried with a spray-drying process or a heat-drying process at a temperature lower than 80° C.

11. The low-temperature co-precipitation method for fabricating transparent conductive oxide powders according to claim 1, wherein said co-precipitation precursor hydroxide powders is calcined at a temperature of 500-1200° C. for 2-10 hours.

12. The low-temperature co-precipitation method for fabricating transparent conductive oxide powders according to claim 1 further comprising a step of fabricating nano-sized particles of said transparent conductive oxide powders into a transparent conductive oxide sputtering target after said Step (h).
